(19) United States
(12) Patent Application Publication
(10) Pub. No.: US 2011/0243247 A1
(43) Pub. Date: Oct. 6, 2011

(54) METHOD OF DECODING A DVB SERVICE, METHOD OF MANAGING THE DECODING, ASSEMBLY OF A DVB-H RECEIVER AND OF A MEMORY AND TERMINAL

(75) Inventors: Joseph Antunes, Massy (FR); Guillaume Defoug, Paris (FR)

(73) Assignee: DIBCOM, Palaiseau (FR)

(21) Appl. No.: 12/809,659

(22) PCT Filed: Dec. 22, 2008
(86) PCT No.: PCT/FR2008/052395

§ 371 Date: Oct. 21, 2010

(30) Foreign Application Priority Data
Dec. 21, 2007 (FR) 07 60309

(51) Int. Cl. H04N 7/26

(52) U.S. Cl. 375/240.25; 375/E07.027

(57) ABSTRACT

Method of decoding a DVB digital television service by a handheld DVB-H digital television receiver intended to be integrated into a terminal, characterized in that it includes: a step of retaining in memory, in a memory of the terminal (2), SI/PSI tables, while the terminal is switched off; a step of switching on (28) the terminal; a step of loading (30) the SI/PSI tables from the memory of the terminal; and a step of attempted decoding (40), of the DVB service using the SI/PSI tables loaded.

The present invention relates to a method of decoding a DVB digital television service by a handheld DVB-H digital television receiver intended to be integrated into a terminal.

It also relates to a method of managing the decoding of a DVB service by a terminal, an assembly of a DVB-H receiver and of a corresponding memory and terminal.

More particularly, the invention relates to the DVB (Digital Video Broadcasting) systems, in particular the broadcasting systems for handheld DVB-H receivers (Digital Video Broadcast for Handheld terminals).

The DVB-H system was introduced in order to be able to broadcast transport streams of the DVB type to a handheld receiver having limited resources in terms of battery.

The data of the DVB transport streams are of two types.

They are thus either useful data which define services or service information called SI/PSI information (Service Information/Program Specific Information) which describe the means in particular in terms of network for accessing the useful data.

The SI service information is defined in the form of tables which define, among other things, a network identifier determining solely the network used for routing the useful data of at least one service by a platform identifier which determines solely the platform supporting the routing of the useful data of the, or of one of these service(s) and by a program identifier of the packets of transport streams TS (Transport Stream) which route the useful data of the or these service(s).

The PSI program specific information is also defined in the form of tables making it possible, among other things, to gain access to the elementary streams constituting a service, for example to each audio and video stream of an audiovisual program service selected by a user and to synchronise the elementary streams during their decoding and their presentation to the user.

In the continuation of the description, the SI/PSI information will be called service information.

This invention is more particularly of advantage for the restoration of a DVB digital television service, typically the programs of a television channel at the switching on of the DVB-H receiver.

Conventionally, at the switching on of the DVB-H receiver, the latter carries out the recovery of the whole of the SI/PSI tables conveyed on the DVB transport stream, this recovery operation having a duration of ten seconds.

The DVB-H receiver then advises the user's terminal, via a message, that it is ready for decoding the DVB services.

Following reception of this message, the terminal requests the receiver to decode the desired television service, or in this case the last service requested by the terminal before the switching off of the receiver.

This has a drawback in that the DVB service is not restored rapidly but only after ten seconds.

The aim of the invention is to solve this problem.

To this end, the subject of the invention is a method of decoding a DVB digital television service by a handheld DVB-H digital television receiver intended to be integrated into a terminal, characterized in that it comprises:
a step of retaining in memory, in a memory of the terminal, SI/PSI tables, while the terminal is switched off;
a step of switching on the terminal;
a step of loading from the memory of the terminal the SI/PSI tables which were retained in memory when the terminal was switched off; and
a step of attempted decoding of said DVB service using the SI/PSI tables loaded.

According to particular embodiments, the method includes one or more of the following features, taken individually or in any technically possible combination:
the switching on of the terminal is performed by a user,
it comprises, between the step of loading and the step of attempted decoding step:
   a step of transmission of a message indicating that the receiver is ready, from the DVB-H receiver to the terminal; and
   a step of reception of a request for decoding said DVB service.
it comprises, after the step of switching on the receiver, a step of updating the SI/PSI service information tables,
it comprises, prior to the step of retaining in memory:
   a step of saving the SI/PSI tables in the memory; and
   a step of switching off the terminal,
the switching off of the terminal is performed by a user.

The invention also has as its subject a method of managing, by means of a terminal comprising a DVB-H digital television receiver, the decoding of a DVB digital television service, characterized in that it comprises the steps of the method of decoding said service by the DVB-H receiver as described above, and in that it further comprises:
between the step of reception of a request for switching off the terminal and the step of switching off the terminal, a step of saving an identifier of the DVB service by the terminal;
between the step of transmission of a message indicating that the receiver is ready and the step of reception of a request for decoding said service:
   a step of reception by the terminal of the message indicating that the receiver is ready; and
   in response to the message indicating that the receiver is ready, a step of transmission, by the terminal, of a request for decoding said DVB service, to the DVB-H receiver.

According to particular embodiments, the method of management includes one or more of the following features, taken individually or in any technically possible combination:
the step of updating each of the SI/PSI tables comprises:
   a step of reading the version field value of the SI/PSI table conveyed by the transport packet TS;
   a step of comparison of the read value of the version field of said SI/PSI table with a recorded value; and

in the case where the read value is different from the recorded value:
a step of recovery of the whole of the SI/PSI table,
the step of updating the SI/PSI service information tables comprises a step of recovery of all the following succeeding SI/PSI service information tables.

The invention also has as its subject an assembly of a DVB-H digital television receiver and of a memory, said assembly being intended to be integrated into a terminal, characterized in that the memory is designed for retaining SI/PSI tables in memory, while the terminal is switched off, and in that the receiver comprises
means for switching on the terminal;
means for loading from the memory the SI/PSI tables which were retained in memory when the terminal was switched off; and
means for attempted decoding of said DVB service using the SI/PSI tables loaded.

According to particular embodiments, the assembly of a receiver and of a memory includes one or more of the following features, taken individually or in any technically possible combination:
the means for switching on the terminal are adapted to be actuated by a user,
the receiver comprises:
   means for transmission, to the terminal, following the loading of the SI/PSI tables, of a message indicating that the receiver is ready;
   means for reception of a request from the terminal for decoding said DVB service,
the receiver comprises means for updating the SI/PSI service information tables,
the receiver comprises:
   means for saving the SI/PSI service information tables in the memory; and
   means for switching off the terminal,
the means for switching off the terminal are adapted to be actuated by a user.

The invention also has as its subject a terminal characterized in that it comprises an assembly of a DVB-H digital television receiver and of a memory such as described above, and in that it further comprises:
means for saving, following the reception of a request for switching off the terminal, an identifier of the current DVB service;
means for reception of the message indicating that the receiver is ready; and
means for transmission, following the reception of the message indicating that the receiver is ready, of a request to the DVB-H receiver for decoding said DVB service, the identifier of which was saved by the saving means.

A description will now be given of the embodiments of the invention in a more precise, but non-limiting, manner, with reference to the appended drawings, in which:

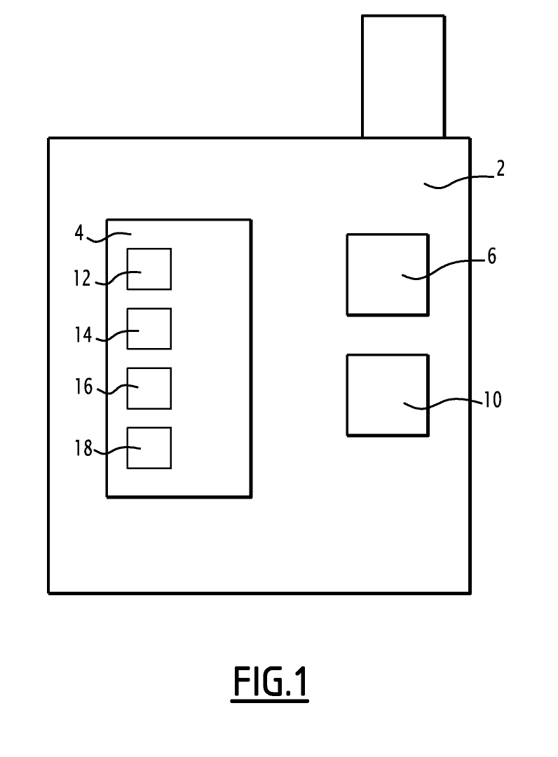

FIG. 1 shows a handheld terminal comprising a device for decoding a digital television service according to the invention; and

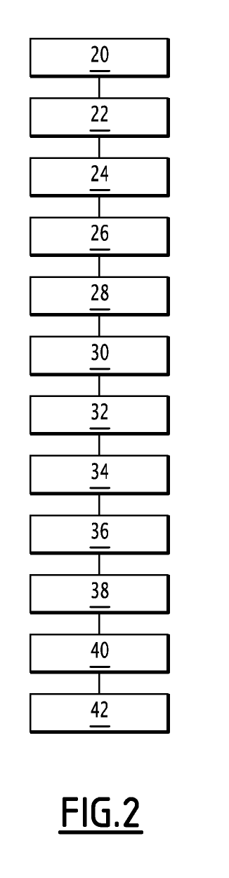

FIG. 2 is a flow diagram illustrating the method of decoding a digital television service according to the invention, implemented by the handheld terminal of FIG. 1.

FIG. 1 illustrates a handheld terminal 2 equipped with a handheld DVB-H digital television receiver 4, with means for transmission/reception 6 between the terminal 2 and the DVB-H receiver 4, and with a memory 10, the content of which is not erased when the terminal is switched off. For example, the memory 10 is of the non-volatile type. As a variant, it is a volatile memory permanently supplied with power by its own battery, separate from the power supply of the handheld terminal 2.

The terminal 2 is equipped with switching means 12 allowing the user to alternately switch on and switch off the terminal 2.

In addition, the DVB-H receiver 4 is equipped with means 14 for loading the data contained in the memory 10.

Moreover, the DVB-H receiver 4 has means 16 for decoding digital television transport streams, the transport streams conveying both DVB services and SI/PSI service information tables. The DVB-H receiver 4 also has means for comparison 18 between version field values of SI/PSI tables, as will be detailed hereinafter.

The structure of the device for decoding digital television services according to the invention having been described, the functioning of the method of decoding is described in the continuation of the description with reference to the appended drawings.

At 20, a user actuates the switching means 12 and thereby transmits a request for switching off the terminal 2 and, consequently, the DVB-H receiver 4.

The DVB-H receiver 4 then, at 22, saves the latest version of the SI/PSI service information tables used by the terminal 2, transmitting them via the transmission/receiving means 6 to the memory 10.

As a variant, the saving of the latest version of the SI/PSI tables is performed at any moment as long as the terminal is switched on.

At 24, the terminal 2 saves, in the memory 10, an identifier of the last digital television service received.

At 26, the terminal 2 is switched off.

While the terminal 2 is switched off, the memory 10 retains the SI/PSI tables in memory.

The continuation of the flow diagram concerns the method of decoding the service, the identifier of which was saved, during the switching on of the terminal 2.

Thus, at 28, the user again actuates the switching means 12 so that the terminal 2 is switched on. The loading means 14 then, at 30, load the SI/PSI service information tables saved at 22 in the memory 10 of the terminal 2.

At 32, the DVB-H receiver 4 transmits, via the transmission/receiving means 6, a message indicating that the receiver 4 is ready for the reception and decoding of digital television services.

At 34, the terminal 2 receives the message. It responds thereto by transmitting at 36, by means of the transmission/receiving means 6, a request to the DVB-H receiver 4 for decoding the digital television service, the identifier of which it saved at 24. This request comprises said identifier.

At 38, the DVB-H receiver 4 receives said request from the terminal 2 by means of the transmission/receiving means 6.

The decoding means 16 then, at 40, attempt to decode the digital television service, the identifier of which was transmitted by the terminal 2, using the SI/PSI tables loaded at 30.

This attempt at decoding at 40 fails in the case where the SI/PSI tables loaded at 30 do not correspond to the latest version of the SI/PSI tables.

Finally, at 42, the decoding means 16 update the SI/PSI tables in order to obtain the latest version of the tables.

This updating at 42 is carried out, according to one embodiment, by recovering all the SI/PSI tables regularly according to a fixed period.

According to another embodiment of the invention, this updating is carried out during reception of the transport packets TS by recovery by the decoding means 16 only of the SI/PSI tables in which the version field values have changed. The updating thus comprises:
a step of reading the version field value of the SI/PSI table conveyed by the transport packet TS;
a step of comparison of the read value of the version field of said SI/PSI table with a recorded value; and

in the case where the read value is different from the recorded value:
a step of recovery of the whole of the SI/PSI table.

Thus, the method according to the invention makes it possible to restore rapidly, when the SI/PSI tables loaded suffice, the last service decoded by the DVB-H receiver before being switched off by means of attempted decoding using the SI/PSI tables saved before the switching off. This avoids having to wait while the loading of the new SI/PSI tables is carried out as in the state of the art.

1. A method of decoding a DVB digital television service by a handheld DVB-H digital television receiver (4) intended to be integrated into a terminal (2), characterized in that it comprises:
a step of retaining in memory, in a memory (10) of the terminal (2), SI/PSI tables, while the terminal (2) is switched off;
a step of switching on (28) the terminal (2);
a step of loading (30) from the memory (10) of the terminal (2) the SI/PSI tables which were retained in memory when the terminal was switched off; and
a step of attempted decoding (40) of said DVB service using the SI/PSI tables loaded.

2. A decoding method according to claim 1, characterized in that the switching on (28) of the terminal (2) is performed by a user.

3. A decoding method according to claim 1, characterized in that it comprises, between the loading step (30) and the attempted decoding step (40):
a step of transmission (32) of a message indicating that the receiver (4) is ready, from the DVB-H receiver (4) to the terminal (2); and
a step of reception of a request (38) for decoding said DVB service.

4. A decoding method according to claim 1, characterized in that it comprises, after the step of switching on the receiver (2), a step of updating (42) the SI/PSI service information tables.

5. A decoding method according to claim 3, characterized in that it comprises, prior to the step of retaining in memory:
a step of saving (22) the SI/PSI tables in the memory (10); and
a step of switching off (26) the terminal (2).

6. A decoding method according to claim 5, characterized in that the switching off (26) of the terminal (2) is performed by a user.

7. A method of managing, by means of a terminal (2) comprising a DVB-H digital television receiver (4), the decoding of a DVB digital television service, characterized in that it comprises the steps of the method of decoding said service by the DVB-H receiver (4) according to claim 5, and in that it further comprises:
between the step of reception of a request (20) for switching off the terminal (2) and the step of switching off (26) the terminal (2), a step of saving (24) an identifier of the DVB service by the terminal (2);
between the step of transmission (32) of a message indicating that the receiver is ready and the step of reception of a request (38) for decoding said service:
a step of reception (34) by the terminal (2) of the message indicating that the receiver is ready; and
in response to the message indicating that the receiver is ready, a step of transmission (36), by the terminal (2), of a request for decoding said DVB service, to the DVB-H receiver (4).

8. A method according to claim 7, characterized in that the step of updating (42) each of the SI/PSI tables comprises:
a step of reading the version field value of the SI/PSI table conveyed by the transport packet TS;
a step of comparison of the read value of the version field of said SI/PSI table with a recorded value; and
in the case where the read value is different from the recorded value:
a step of recovery of the whole of the SI/PSI table.

9. A method according to claim 7, characterized in that the step of updating (42) the SI/PSI service information tables comprises a step of recovery of all the following succeeding SI/PSI service information tables.

10. An assembly of a DVB-H digital television receiver (4) and of a memory (10), said assembly being intended to be integrated into a terminal (2), characterized in that the memory (10) is designed to retain SI/PSI tables in memory, while the terminal (2) is switched off, and in that the receiver (4) comprises
means for switching on (12) the terminal (2);
means for loading (14) from the memory (10) the SI/PSI tables which were retained in memory when the terminal was switched off; and
means for attempted decoding (16) of said DVB service using the SI/PSI tables loaded.

11. An assembly according to claim 10, characterized in that the means for switching on (12) the terminal (2) are adapted to be actuated by a user.

12. An assembly according to claim 10, characterized in that the receiver comprises:
means for transmission (6), to the terminal (2), following the loading of the SI/PSI tables, of a message indicating that the receiver is ready;
means for reception (6) of a request from the terminal (2) for decoding said DVB service.

13. An assembly according to claim 10, characterized in that the receiver comprises means for updating (16) SI/PSI service information tables.

14. An assembly according to claim 10, characterized in that the receiver comprises:
means for saving SI/PSI service information tables in the memory (10); and
means for switching off (12) the terminal (2).

15. An assembly according to claim 14, characterized in that the means for switching off (12) the terminal (2) are adapted to be actuated by a user.

16. A terminal (2), characterized in that it comprises an assembly of a DVB-H digital television receiver (4) and of a memory (10) according to claim 10, and in that it further comprises:
means for saving, following the reception of a request for switching off the terminal (2), an identifier of the current DVB service;
means for reception (6) of the message indicating that the receiver is ready; and
means for transmission (6), following the reception of the message indicating that the receiver is ready, of a request to the DVB-H receiver (4) for decoding said DVB service, the identifier of which was saved by the saving means.

17. A decoding method according to claim 2, characterized in that it comprises, between the loading step (30) and the attempted decoding step (40):
a step of transmission (32) of a message indicating that the receiver (4) is ready, from the DVB-H receiver (4) to the terminal (2); and
a step of reception of a request (38) for decoding said DVB service.

18. A decoding method according to claim 2, characterized in that it comprises, after the step of switching on the receiver (2), a step of updating (42) the SI/PSI service information tables.

19. A decoding method according to claim 3, characterized in that it comprises, after the step of switching on the receiver (2), a step of updating (42) the SI/PSI service information tables.

20. A decoding method according to claim 1, characterized in that it comprises, prior to the step of retaining in memory:
a step of saving (22) the SI/PSI tables in the memory (10); and
a step of switching off (26) the terminal (2).
